(19) United States
(12) Patent Application Publication
(10) Pub. No.: US 2023/0162022 A1
(43) Pub. Date: May 25, 2023

(54) Importance Sampling with Bandwidth Constraints

(71) Applicant: VMware, Inc., Palo Alto, CA (US)

(72) Inventors: Yaniv Ben-Itzhak, Herzliya (IL); Shay Vargaftik, Herzliya (IL); Boris Shustin, Tel Aviv (IL)

(21) Appl. No.: 17/535,479

(22) Filed: Nov. 24, 2021

(51) Int. Cl. G06N 3/08; G06F 9/54

(52) U.S. Cl. CPC G06N 3/08; G06F 9/54

(57) ABSTRACT

At an iteration k of a training procedure for training a deep neural network (DNN), a first computer system can sample a batch b^{k} of data instances from a training dataset local to that computer system in a manner that mostly conforms to importance sampling probabilities of the data instances, but also applies a “stiffness” factor with respect to data instances appearing in batch b^{k-1} of a prior iteration k−1. This stiffness factor makes it more likely, or guarantees, that some portion of the data instances in prior batch b^{k-1}—which is present on a second computer system holding the DNN—will be reused in current batch b^{k}. The first computer system can then transmit the new data instances in batch b^{k} to the second computer system and the second computer system can reconstruct batch b^{k} using the received new data instances and its local copy of prior batch b^{k-1}.

### BACKGROUND

Unless otherwise indicated, the subject matter described in this section is not prior art to the claims of the present application and is not admitted as being prior art by inclusion in this section.

Deep neural networks (DNNs), which are machine learning (ML) models composed of multiple layers of interconnected nodes, are widely used to solve tasks in various fields such as computer vision, natural language processing, telecommunications, bioinformatics, and so on. A DNN is typically trained via a batch-based stochastic gradient descent (SGD) training procedure that involves (1) randomly sampling a batch (sometimes referred to as a “minibatch”) of labeled data instances from a training dataset, (2) forward propagating the batch through the DNN to generate a set of predictions, (3) computing a difference (i.e., “loss”) between the predictions and the batch's labels, (4) performing backpropagation through the DNN with respect to the loss to compute a gradient estimate, (5) updating the DNN's parameters in accordance with the gradient estimate, and (6) iterating steps (1)-(5) until the DNN converges (i.e., reaches a state where the loss falls below a desired threshold). Once trained in this manner, the DNN can be applied during an inference phase to generate predictions for unlabeled data instances.

Generally speaking, the use of larger datasets for training results in more accurate DNNs. However, as the amount of training data increases, the computational overhead and time needed to carry out the SGD training procedure also rises. To address this, importance sampling has been proposed as a technique for accelerating the training of DNNs. With importance sampling, each data instance in the training dataset is assigned an importance sampling probability that corresponds to the “importance” of the data instance to the training procedure, or in other words the degree to which that data instance contributes to progress of the training towards model convergence. Then, at each training iteration, data instances are sampled from the training dataset based on their respective importance sampling probabilities rather than at random, thereby causing more important data instances to be selected with higher likelihood than less important data instances and leading to an overall reduction in training time. It has been found that the optimal sampling probability for a given data instance is proportional to the norm (i.e., size) of the gradient computed for that data instance via SGD.

While existing importance sampling implementations work reasonably well if the training dataset and DNN are co-located, in many real-world scenarios the training dataset will be held by a first computer system (or group of systems) and the DNN will be trained by a second computer system (or group of systems) that is remote from the first computer system. In these scenarios, network congestion and/or other issues may introduce fluctuating bandwidth constraints that limit, to varying degrees, the amount of training data (and thus data instance batch size) that may be communicated from the first computer system to the second computer system in each training iteration. Because larger batch sizes generally result in faster training, a reduction in batch size caused by such bandwidth constraints can undesirably negate some or all of the speed gains provided by importance sampling.

### BRIEF DESCRIPTION OF THE DRAWINGS

FIG. 1 depicts an example environment in which embodiments of the present disclosure may be implemented.

FIG. 2 depicts an example DNN.

FIG. 3 depicts a flowchart for training a DNN via a batch-based SGD training procedure with importance sampling according to certain embodiments.

FIG. 4 depicts a workflow of an enhanced importance sampling solution according to certain embodiments.

FIG. 5 depicts a flowchart of a first implementation of the solution of FIG. 4 according to certain embodiments.

FIG. 6 depicts a flowchart of a second implementation of the solution of FIG. 4 according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to techniques for implementing importance sampling in the presence of bandwidth constraints. For example, consider a scenario in which (1) a first computer system holds (i.e., maintains in local storage) a training dataset, (2) a second computer system remote from the first computer system trains a DNN on that training dataset using a batch-based SGD training procedure with importance sampling, and (3) the first and second computer systems are subject to one or more bandwidth constraints that limit the amount of data that may be communicated between the systems over the course of the training procedure.

In this and other similar scenarios, the first computer system can, at each training iteration k, sample data instances from the training dataset for inclusion in batch b^{k} of k in a manner that mostly conforms to the conventional (e.g., optimal or near-optimal) importance sampling probabilities of the data instances, but also applies a “stiffness” factor with respect to data instances appearing in batch b^{k-1} of prior iteration k−1. This stiffness factor makes it more likely, or guarantees, that some portion of the data instances in prior batch b^{k-1}—which are already present on the second computer system by virtue of being processed in iteration k−1—will be reused (i.e., included again) in current batch b^{k}. The first computer system can then transmit the “new” data instances in batch b^{k} (i.e., those that are not also in prior batch b^{k-1}) to the second computer system, and the second computer system can reconstruct the entirety of batch b^{k} using the received new data instances and local copies of the reused data instances from batch b^{k-1}. Finally, the second computer system can execute iteration k of the training procedure using reconstructed batch b^{k}.

In one set of embodiments, the stiffness factor can be implemented probabilistically by modifying the importance sampling probability distribution used for sampling batch b^{k} in a way that favors/prioritizes data instances appearing in prior batch b^{k-1} over those not appearing in b^{k-1} according to a weight Qₖ. Weight Qₖ can be chosen such that, on average, the number of new data instances in batch b^{k} (and thus the number of data instances that need to be sent from the first computer system to the second computer system in iteration k) will be less than or equal to a data instance limit Lₖ imposed by bandwidth constraints in effect at the time of k. In another set of embodiments, the stiffness factor can be implemented deterministically by bounding the number of new data instances in batch b^{k} according to a fixed value nₖ that is less than or equal to limit Lₖ.

With this general approach—which effectively recycles certain data instances from prior batches that are locally available to the second computer system for use in subsequent batches—the amount of training data that is sent from the first computer system to the second computer system in each iteration can be substantially reduced, thereby allowing the training procedure to adhere to the bandwidth constraints placed on those systems.

### 2. Example Environment and High-Level Solution Design

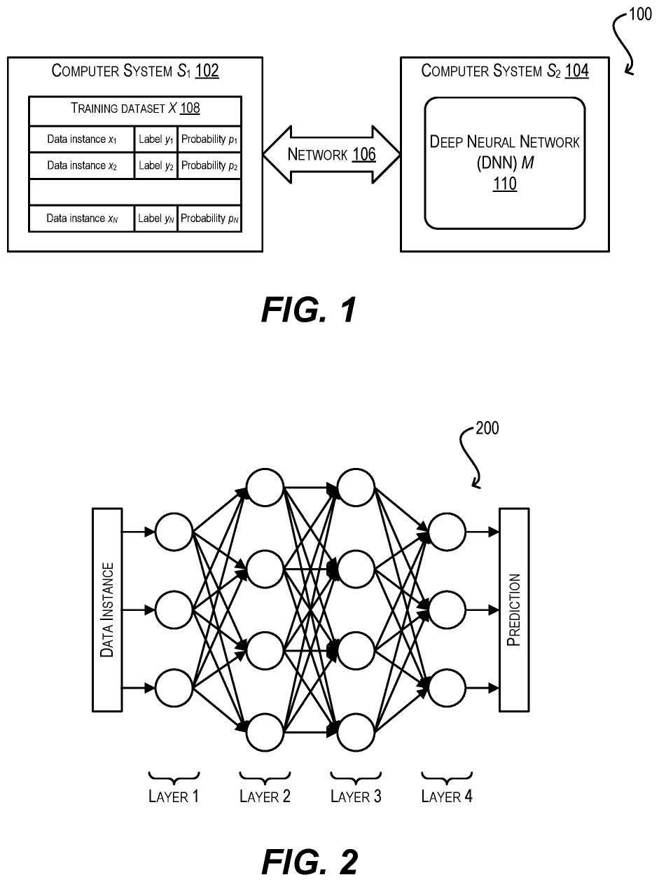

FIG. 1 depicts an example environment 100 in which embodiments of the present disclosure may be implemented. As shown, environment 100 includes two computer systems S₁ and S₂ (reference numerals 102 and 104) that are communicatively coupled via a network 106. Computer system S₁ holds a training dataset X (reference numeral 108 that comprises N data instances x₁, . . . , x_{N}, each associated with a label yᵢ indicating the correct prediction/output for that data instance and an importance sampling probability pᵢ indicating the training importance of that data instance.

Computer system S₂ holds a DNN M (reference numeral 110) and is configured to train M on training dataset X. A DNN is type of ML model that comprises a collection of nodes, also known as neurons, that are organized into layers and interconnected via directed edges. For instance, FIG. 2 depicts an example representation 200 of DNN M that includes a total of fourteen nodes and four layers 1-4. The nodes and edges are associated with parameters (e.g., weights and biases, not shown) that control how a data instance, when provided as input via the first layer, is forward propagated through the DNN to generate a prediction, which is output by the last layer. These parameters are the aspects of the DNN that are adjusted via training in order to optimize the DNN's accuracy (i.e., ability to generate correct predictions).

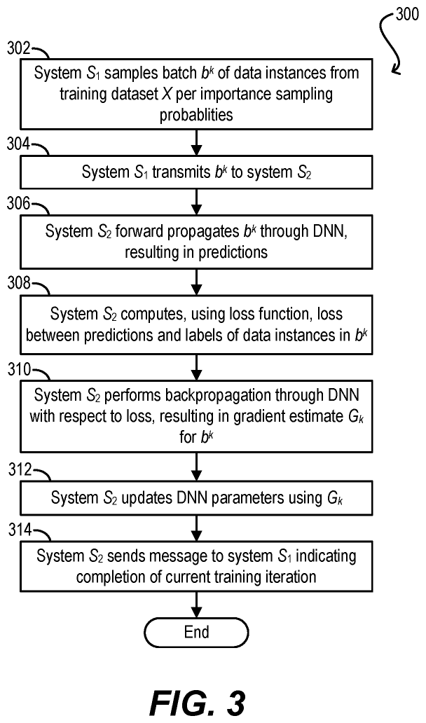

FIG. 3 depicts a flowchart 300 that may be executed by computer systems S₁ and S₂ for training DNN M on training dataset X using a batch-based SGD training procedure with conventional importance sampling. Generally speaking, the goal of this training procedure is to minimize a risk function

$${F}_{N} ( x ) := \frac{1}{N} {Σ}_{i = 1}^{N} f ( x , {ξ}_{i} ) := \frac{1}{N} {Σ}_{i = 1}^{N} {f}_{i} ( x )$$

where x represents the parameters of the output (i.e., prediction) generated by DNN M, ξᵢ represents a data instance xᵢ and its corresponding label yᵢ in training dataset X, and f(x, ξᵢ) is a loss function computed on x and ξᵢ. Flowchart 300 depicts the steps performed in a single training iteration k.

Starting with steps 302 and 304, computer system S₁ samples a batch b^{k} of data instances from training dataset X in accordance with current importance sampling probabilities p₁^{k}, . . . , p_{N}^{k} in X and transmits b^{k} to computer system S₂.

At step 306, computer system S₂ forward propagates batch b^{k} through DNN M, resulting in a set of predictions. Computer system S₂ further computes a loss between the predictions and the labels of the data instances in batch b^{k} using loss function f (step 308) and performs backpropagation through DNN M with respect to the computed loss, resulting in a gradient estimate Gₖ for b^{k} (step 310). In a particular embodiment, this gradient estimate can be computed as shown below, where bᵢ^{k} represents data instance xᵢ in batch b^{k} and p_{b}_{ᵢ}_{^{k}}^{k} represents the importance sampling probability of bᵢ^{k} at iteration k:

$${G}_{k} := \frac{1}{\vert {b}^{k} \vert} {{\sum }^{\vert {b}^{k} \vert}}_{i = 1} \frac{1}{N {p}_{{b}_{i}^{k}}^{k}} ∇ {f}_{{b}_{i}^{k}} ( {x}^{k} ) \qquad Listing 1$$

Finally, computer system S₂ updates the parameters of DNN M using gradient estimate Gₖ (step 312), sends a message to computer system S₁ indicating completion of the current iteration k (step 314), and the flowchart ends. Steps 302-314 are thereafter repeated for further iterations until DNN M converges (i.e., achieves a desired level of accuracy) or some other termination criterion, such as a maximum number of training iterations, is reached.

In some embodiments, prior to the sending the message to computer system S₁ at step 314, computer system S₁ can compute, based on the current state of DNN M, updated importance sampling probabilities p₁^{k+1}, . . . , p_{N}^{k+1} corresponding to data instances x₁, . . . , x_{N} for use in next training iteration k+1 and can include these updated importance sampling probabilities in the message. According to one approach, the computation of each pᵢ^{k+1} can comprise taking the norm (i.e., size) of the gradient for data instance xᵢ in iteration k and dividing that value by the sum of the gradient norms of all data instances as shown below:

$${p}_{i}^{k + 1} = \frac{‖ ∇ {f}_{i} ( {x}_{k} ) ‖}{{\sum }_{j ∈ X} ‖ ∇ {f}_{j} ( {x}_{k} ) ‖} \qquad Listing 2$$

Computer system S₁ can then receive the updated importance sampling probabilities and store them in training dataset X, thereby overwriting prior probabilities p₁^{k}, . . . , p_{N}^{k}. In alternative embodiments, the computation of updated importance sampling probabilities p₁^{k+1}, . . . , p_{N}^{k+1} can be performed by a different entity and/or via a different method, such as an ML-based gradient approximation approach that is disclosed in commonly owned U.S. patent application Ser. No. 17/518,107 (Atty. Docket No. H833 (86-38800)), entitled “Importance Sampling via Machine Learning (ML)-Based Gradient Approximation.”

As mentioned previously, in some scenarios computer systems S₁ and S₂ may be subject to one or more hard or soft bandwidth constraints that place a limit on the number of data instances that may be communicated from S₁ to S₂ at each training iteration k. A hard network bandwidth constraint is one where the data instance limit cannot be exceeded due to, e.g., characteristics of the systems or the network. For example, computer system S₂ may be an edge device (e.g., a smartphone, tablet, Internet of Things (IoT) device, etc.) with unstable network reception and/or network hardware that is constrained by power limitations. A soft network bandwidth constraint is one where the data instance limit can be exceeded, but there are reasons/motivations to avoid doing so. For example, computer system S₁ may be part of a cloud storage service platform such as Amazon S3 that charges customers a fee for every M units of data that are retrieved from the platform, thereby motivating the owner/operator of computer system S₂ to stay within the per-iteration limit in order to minimize training costs. The presence of these hard or soft bandwidth constraints are problematic because they can significantly lengthen the overall time need to train DNN M.

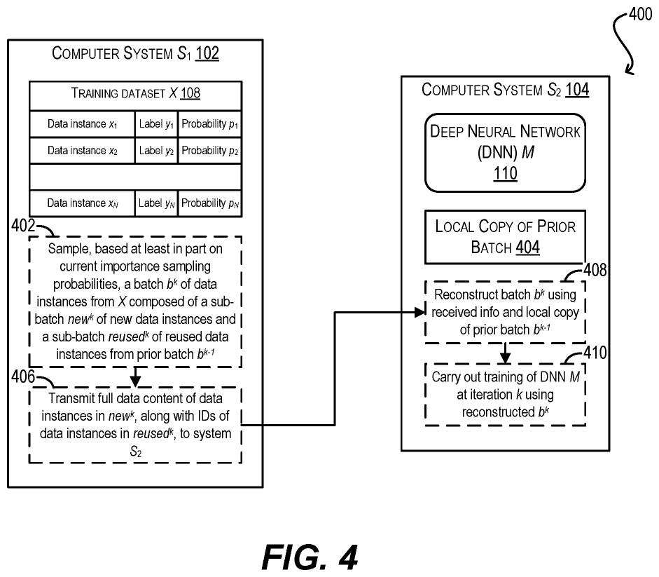

To address the foregoing and other similar problems, FIG. 4 depicts a high-level workflow 400 of an enhanced importance sampling solution that can be implemented by computer systems S₁ and S₂ of FIG. 1 as part of training DNN M according to certain embodiments. Workflow 400 illustrates the steps of this enhanced solution with respect to a single training iteration k.

Starting with step 402, computer system S₁ can sample, based at least in part on importance sampling probabilities p₁^{k}, . . . , p_{N}^{k}, a batch b^{k} of data instances from training dataset X composed of two logically distinct sub-batches: a first sub-batch reused^{k} that comprises zero or more data instances from batch b^{k-1} of immediately prior iteration k−1 and a second sub-batch new^{k} that comprises zero or more data instances from the entirety of training dataset X (or a subset of X that excludes batch b^{k-1}). It is assumed that the sizes of these two sub-batches add up to a desired batch size B for batch b^{k}. Further, it is assumed that computer system S₂ maintains, in a local memory or storage, a copy 404 of the data instances in batch b^{k-1} by virtue of having processed those data instances during prior iteration k−1.

In various embodiments, computer system S₁ can perform the sampling at step 402 in a manner that makes it likely, or guarantees, that the size of sub-batch new^{k} will not exceed a limit Lₖ on the number of data instances that may be sent from S₁ to S₂ in iteration k, per the bandwidth constraints in effect at the time of k. For example, according to one set of embodiments (referred to herein as the “probabilistic approach” and detailed in section (3) below), computer system S₁ can select a weight Qₖ between 0 and 1, modify (or compute) importance sampling probabilities p₁^{k}, . . . , p_{N}^{k} such that the sum of the probabilities of the data instances in prior batch b^{k-1} equals Qₖ (and conversely, the sum of the probabilities of the data instances not in b^{k-1} equals (1−Qₖ)), and sample batch b^{k} from training dataset X in accordance with these modified importance sampling probabilities (resulting in a natural partitioning of data instances in b^{k} into sub-batches new^{k} and reused^{k}). By selecting a sufficiently large value for weight Qₖ, computer system S₁ can bias the sampling process to probabilistically favor the selection of data instances in prior batch b^{k-1} over data instances that are not in b^{k-1} (while maintaining the relative differences in training importance between the data instances in each of these groups) and thereby make it likely that the size of sub-batch new^{k} will not exceed data instance limit Lₖ.

According to another set of embodiments (referred to herein as the “deterministic approach” and detailed in section (4) below), computer system S₁ can directly fix the size of sub-batch new^{k} to a value nₖ that is less than or equal data instance limit Lₖ. In addition, computer system S₁ can fix the size of sub-batch reused^{k} to B−nₖ. Computer system S₁ can then perform two independent sampling procedures as part of step 402: (1) a first sampling procedure that samples nₖ data instances from training dataset X for inclusion in sub-batch new^{k} based on importance sampling probabilities p₁^{k}, . . . , p_{N}^{k} in X, and (2) a second sampling procedure that samples B−nₖ data instances from prior batch b^{k-1} for inclusion in sub-batch reused^{k} based on another set of sampling probabilities q_{b}_{₁}_{^{k−1}}^{k}, . . . , q_{b}_{_{B}}_{^{k−1}}^{k} that are specific to the members of b^{k-1}. Sampling probabilities q_{b}_{₁}_{^{k−1}}^{k}, . . . , q_{b}_{_{B}}_{^{k−1}}^{k} can be defined in several different ways, which are discussed in section (4).

Once batch b^{k} and its constituent sub-batches new^{k} and reused^{k} have been sampled/determined, computer system S₁ can transmit the full data content of the data instances in new^{k}, along with identifiers (IDs) of the data instances in reused^{k}, to computer system S₂ (step 408). In response, computer system S₂ can reconstruct batch b^{k} by retrieving, from its local copy 404 of prior batch b^{k-1}, the data instances identified as being included in sub-batch reused^{k} and combining those data instances with the received data instances in sub-batch new^{k} (step 406).

Finally, at step 410, computer system S₂ can carry out the training of DNN M for iteration k using reconstructed batch b^{k} (per, e.g., steps 306-314 of flowchart 300) and workflow 400 can end.

With the enhanced importance sampling solution shown in FIG. 4, a number of advantages are achieved. First, because computer system S₁ only needs to send the contents of the data instances in sub-batch new^{k} of batch b^{k} to computer system S₂ (due the existence of a local copy of prior batch b^{k-1} at S₂), this solution significantly reduces the amount of training data that needs to be communicated over network 106 in each training iteration, which in turn enables the training procedure to operate successfully in the presence of network bandwidth constraints. As mentioned previously, in various embodiments sub-batch new^{k} can be sampled/constructed in a manner that ensures, or at least makes it probable, that its size will not exceed a data instance limit Lₖ imposed by the bandwidth constraints present at the time of iteration k.

Second, because this solution still leverages, at least in part, importance sampling probabilities to sample data instances and allows for the use of a constant (e.g., large) batch size, the gains in training speed provided by these features/optimizations can be mostly preserved.

It should be appreciated FIGS. 1-4 and the foregoing description are illustrative and not intended to limit embodiments of the present disclosure. For example, although workflow 400 of FIG. 4 indicates that computer system S₁ sends IDs of the data instances in sub-batch reused^{k} to computer system S₂ at step 406 in order to facilitate reconstruction of batch b^{k} at S₂, in some embodiments this may not be needed. For example, it is possible for computer system S₂ to independently carry out the exact same sampling process executed by computer system S₁ at step 402 (using, e.g., a mutually agreed-upon random number generator seed value) and thereby determine the data instances in sub-batch reused^{k}. Accordingly, in these embodiments computer system S₁ can simply provide the content of the data instances in sub-batch new^{k} to computer system S₂ at step 406 and S₂ can thereafter reconstruct batch b^{k} using that data and its local sampling of reused^{k}.

Further, although computer systems S₁ and S₂ are shown in FIG. 1 as singular systems, each of these entities may implemented using multiple computer systems for increased performance, redundancy, and/or other reasons.

Yet further, in certain embodiments training dataset X and DNN M may be held by two different components C₁ and C₂ of a single computer system S that are subject to inter-component, rather than network, bandwidth constraints. For example, training dataset X may be stored in a memory or storage component that is accessible by a central processing unit (CPU) of S, while DNN M may be held and trained by a graphics processing unit (GPU) of S that is coupled with the CPU via a peripheral bus. In these embodiments, the same techniques described with respect to computer systems S₁ and S₂ may be applied to components C₁ and C₂ for implementing importance sampling in the presence of bandwidth constraints (arising out of, e.g., bus bandwidth limitations, bus contention, etc.) between the components.

### 3. Probabilistic Approach

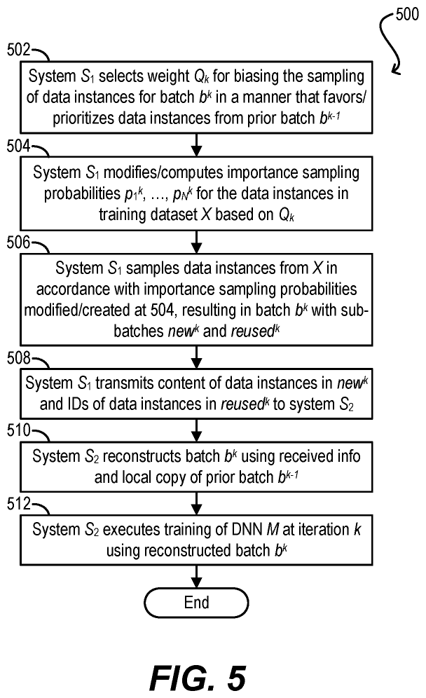

FIG. 5 depicts a flowchart 500 that may be performed by computer systems S₁ and S₂ for implementing the enhanced importance sampling solution of FIG. 4 via the probabilistic approach according to certain embodiments. Like workflow 400, flowchart 500 illustrates the steps performed in a single training iteration k.

Starting with step 502, computer system S₁ can select a weight value Qₖ where 0≤Qₖ≤1 and where Qₖ is intended to bias the sampling of data instances for batch b^{k} of iteration k in a manner that favors data instances appearing in batch b^{k-1} of prior iteration k−1 over those not appearing in batch b^{k-1}. In certain embodiments, computer system S₁ can select Qₖ in consideration of data instance limit Lₖ mentioned previously, such that it will be unlikely for the number of new data instances in batch b^{k} (or in other words, the size of sub-batch new^{k}) to exceed Lₖ.

At step 504, computer system S₁ can modify (or compute) importance sampling probabilities p₁^{k}, . . . , p_{N}^{k} for the data instances in training dataset X according to the constraint that the sum of the probabilities for the data instances in batch b^{k-1} equals Qₖ (i.e., Σ_{iϵb}_{^{k−1}}p_{b}_{ᵢ}_{^{k−1}}^{k}=Qₖ). In the scenario where computer system S₁ computes importance sampling probabilities p₁^{k}, . . . , p_{N}^{k} from scratch, S₁ can compute pᵢ^{k} for each data instance xᵢ in batch b^{k-1} (i.e., ∀i ϵ b^{k-1}) and each data instance xᵢ not in batch b^{k-1} (i.e., ∀i ∉ b^{k-1}) as follows according to one embodiment:

$$\begin{matrix}∀ i ∈ {b}^{k - 1} : {p}_{i}^{k} = {Q}_{k} \frac{‖ ∇ {f}_{i} ( {x}_{k} ) ‖}{{\sum }_{j ∈ {b}_{j}^{k - 1}} ‖ ∇ {f}_{j} ( {x}_{k} ) ‖} \\ ∀ i ∉ {b}^{k - 1} : {p}_{i}^{k} = ( 1 - {Q}_{k} ) \frac{‖ ∇ {f}_{i} ( {x}_{k} ) ‖}{{\sum }_{j ∈ {b}_{j}^{k - 1}} ‖ ∇ {f}_{j} ( {x}_{k} ) ‖}\end{matrix} \qquad Listing 3$$

At step 506, computer system S₁ can sample data instances from training dataset X in accordance with the importance sampling probabilities modified/computed at step 504, resulting in batch b^{k} comprising sub-batches new^{k} and reused^{k}. Computer system S₁ can then transmit (1) the content of the data instances in sub-batch new^{k} and (2) IDs of the data instances in sub-batch reused^{k} (without the content of those data instances) to computer system S₂ (step 508).

At step 510, computer system S₂ can receive (1) and (2) from computer system S₁ and can reconstruct the entirety of batch b^{k} using the received information and its local copy 404 of prior batch b^{k-1}. For example, for each data instance ID received for sub-batch reused^{k}, computer system S₂ can retrieve the content of that data instance from local copy 404. As part of this step, computer system S₂ can overwrite local copy 404 with the contents of reconstructed batch b^{k}.

Finally, at step 512, computer system S₂ can execute the training of DNN M at iteration k using reconstructed batch b^{k} and flowchart 500 can end. Although not shown in flowchart 500, in certain embodiments computer system S₂ may transmit a message to computer system S₁ at the conclusion of iteration k that includes gradient (or gradient norm) information which S₁ can use to compute updated importance sampling probabilities (per step 504) in the next iteration k+1.

In alternative embodiments, computer system S₂ may directly compute updated importance sampling probabilities in accordance with steps 502 and 504 and provide those probabilities to computer system S₁ for use in the next iteration.

### 4. Deterministic Approach

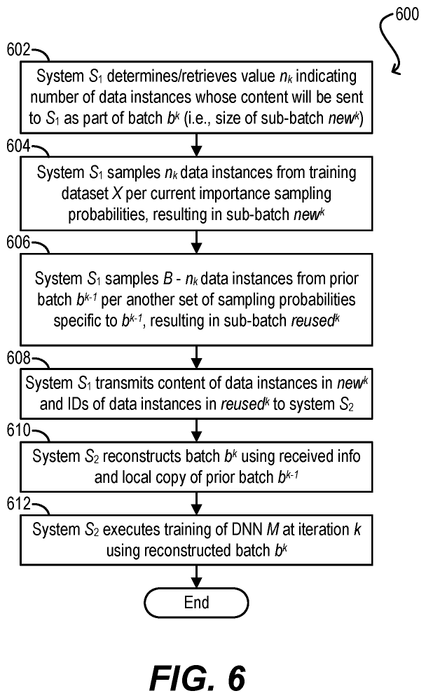

FIG. 6 depicts a flowchart 600 that may be performed by computer systems S₁ and S₂ for implementing the enhanced importance sampling solution of FIG. 4 via the deterministic approach according to certain embodiments. Like workflows/flowcharts 400 and 500, flowchart 600 illustrates the steps performed in a single training iteration k.

Starting with step 602, computer system S₁ can determine or retrieve a value nₖ indicating the number of data instances whose contents will be transmitted to computer system S₂ as part of batch b^{k} of iteration k (or in other words, the size of sub-batch new^{k}), where nₖ is less than or equal to the data instance limit Lₖ.

At step 604, computer system S₁ can sample nₖ data instances from training dataset X (or from a subset of data instances in X that excludes those in prior batch b^{k}) in accordance with their current importance sampling probabilities p₁^{k}, . . . , p_{N}^{k}. This group of nₖ data instances constitutes sub-batch new^{k} of batch b^{k}.

In addition, at step 606, computer system S₁ can sample B−nₖ data instances from prior batch b^{k-1} (where B is the batch size for b^{k}) in accordance with a set of sampling probabilities q_{b}_{₁}_{^{k−1}}^{k}, . . . , q_{b}_{_{B}}_{^{k−1}}^{k} determined for the data instances in b^{k-1}. This group of B−nₖ data instances constitutes sub-batch reused^{k} of batch b^{k}.

In one set of embodiments, computer system S₁ can define sampling probabilities q_{b}_{₁}_{^{k−1}}^{k}, . . . , q_{b}_{_{B}}_{^{k−1}}^{k} using a uniform distribution such that all the probabilities are equal (i.e., q_{b}_{₁}_{^{k−1}}^{k}= . . . =q_{b}_{_{B}}_{^{k−1}}^{k}:=q where 0≤q<1 and Σᵢ₌₁^{B}q_{b}_{ᵢ}_{^{k−1}}^{k}=1). In these embodiments, if a data instance xᵢ in prior batch b^{k-1} also appeared in the batch before that one (i.e., b^{k-2}), computer system S₁ can optionally “penalize” xᵢ—or other words reduce its likelihood of being sampled for current batch b^{k-1}—by reducing its sampling probability q_{b}_{ᵢ}_{^{k−1}}^{k} by some factor and increasing the sampling probabilities of all other data instances in b^{k-1} accordingly.

In another set of embodiments, computer system S₁ can define sampling probabilities q_{b}_{₁}_{^{k−1}}^{k}, . . . , q_{b}_{_{B}}_{^{k−1}}^{k} to reflect the relative training importance of the data instances in batch b^{k-1}, thereby increasing the probability that more important data instances in b^{k-1} will be sampled at step 606. In a particular embodiment, this can be achieved by computing each q_{b}_{ᵢ}_{^{k−1}}^{k} as follows:

$${q}_{{b}_{i}^{k - 1}}^{k} = \frac{‖ ∇ {f}_{i} ( {x}_{k} ) ‖}{{\sum }_{j ∈ {b}_{j}^{k - 1}} ‖ ∇ {f}_{j} ( {x}_{k} ) ‖} \qquad Listing 4$$

Upon completing steps 604 and 606, computer system S₁ can then transmit (1) the content of the data instances in sub-batch new^{k} and (2) IDs of the data instances in sub-batch reused^{k} (without the content of those data instances) to computer system S₂ (step 608). In response, computer system S₂ can receive (1) and (2) from computer system S₁ and can reconstruct the entirety of batch b^{k} using the received information and its local copy 404 of prior batch b^{k-1} (step 610). For example, for each data instance ID received for sub-batch reused^{k}, computer system S₂ can retrieve the content of that data instance from local copy 404. As part of this step, computer system S₂ can further overwrite local copy 404 with the contents of reconstructed batch b^{k}.

Finally, at step 612, computer system S₂ can execute the training of DNN M at iteration k using reconstructed batch b^{k} and flowchart 600 can end.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
sampling, by a first computer system, a batch of data instances from a training dataset local to the first computer system, wherein the sampling is based at least in part on importance sampling probabilities associated with the training dataset, and wherein the batch is composed of a first sub-batch of new data instances not present in a prior batch and a second sub-batch of reused data instances present in the prior batch; and
transmitting, by the first computer system, contents of the new data instances in the first sub-batch and identifiers of the reused data instances in the second sub-batch to a second computer system.

2. The method of claim 1 wherein the second computer system:
reconstructs the batch using the contents of the new data instances, the identifiers of the reused data instances, and a local copy of the prior batch; and
executes an iteration of a batch-based training procedure for training a local machine learning (ML) model using the reconstructed batch.

3. The method of claim 1 wherein the first and second computer systems are subject to one or more bandwidth constraints that place a limit on a number of data instances that may be communicated between the first and second computer systems, and wherein a size of the first sub-batch is less than or equal to the limit.

4. The method of claim 1 wherein the sampling comprises selecting a weight for that favors sampling of data instances present in the prior batch.

5. The method of claim 4 wherein the sampling further comprises:
modifying or computing the importance sampling probabilities based on the weight; and
sampling data instances from the training dataset in accordance with the modified or computed importance sampling probabilities.

6. The method of claim 1 wherein the sampling comprises:
setting a size of the first sub-batch to a value n; and
sampling n data instances from the training dataset in accordance with the importance sampling probabilities.

7. The method of claim 6 wherein the sampling further comprises:
sampling B−n data instances from the prior batch in accordance with a set of sampling probabilities different from the importance sampling probabilities, wherein B is a desired batch size for the batch.

8. A non-transitory computer readable storage medium having stored thereon program code executable by a first computer system holding a training dataset, the program code causing the first computer system to execute a method comprising:
sampling a batch of data instances from the training dataset, wherein the sampling is based at least in part on importance sampling probabilities associated with the training dataset, and wherein the batch is composed of a first sub-batch of new data instances not present in a prior batch and a second sub-batch of reused data instances present in the prior batch; and
transmitting contents of the new data instances in the first sub-batch and identifiers of the reused data instances in the second sub-batch to a second computer system.

9. The non-transitory computer readable storage medium of claim 8 wherein the second computer system:
reconstructs the batch using the contents of the new data instances, the identifiers of the reused data instances, and a local copy of the prior batch; and
executes an iteration of a batch-based training procedure for training a local machine learning (ML) model using the reconstructed batch.

10. The non-transitory computer readable storage medium of claim 8 wherein the first and second computer systems are subject to one or more bandwidth constraints that place a limit on a number of data instances that may be communicated between the first and second computer systems, and wherein a size of the first sub-batch is less than or equal to the limit.

11. The non-transitory computer readable storage medium of claim 8 wherein the sampling comprises selecting a weight that favors sampling of data instances present in the prior batch.

12. The non-transitory computer readable storage medium of claim 11 wherein the sampling further comprises:
modifying or computing the importance sampling probabilities based on the weight; and
sampling data instances from the training dataset in accordance with the modified or computed importance sampling probabilities.

13. The non-transitory computer readable storage medium of claim 8 wherein the sampling comprises:
setting a size of the first sub-batch to a value n; and
sampling n data instances from the training dataset in accordance with the importance sampling probabilities.

14. The non-transitory computer readable storage medium of claim 13 wherein the sampling further comprises:
sampling B−n data instances from the prior batch in accordance with a set of sampling probabilities different from the importance sampling probabilities, wherein B is a desired batch size for the batch.

15. A computer system comprising:
a processor;
a storage component holding a training dataset; and
a non-transitory computer readable medium having stored thereon program code that, when executed by the processor, causes the processor to:
sample a batch of data instances from the training dataset, wherein the sampling is based at least in part on importance sampling probabilities associated with the training dataset, and wherein the batch is composed of a first sub-batch of new data instances not present in a prior batch and a second sub-batch of reused data instances present in the prior batch; and
transmit contents of the new data instances in the first sub-batch and identifiers of the reused data instances in the second sub-batch to another computer system.

16. The computer system of claim 15 wherein said another computer system:
reconstructs the batch using the contents of the new data instances, the identifiers of the reused data instances, and a local copy of the prior batch; and
executes an iteration of a batch-based training procedure for training a local machine learning (ML) model using the reconstructed batch.

17. The computer system of claim 15 wherein the computer system and said another computer system are subject to one or more bandwidth constraints that place a limit on a number of data instances that may be communicated between them, and wherein a size of the first sub-batch is less than or equal to the limit.

18. The computer system of claim 15 wherein the program code that causes the processor to sample the batch comprises program code that causes the processor to select a weight that favors sampling of data instances present in the prior batch.

19. The computer system of claim 15 wherein the program code that causes the processor to sample the batch further comprises program code that causes the processor to:
modify or compute the importance sampling probabilities based on the weight; and
sample data instances from the training dataset in accordance with the modified or computed importance sampling probabilities.

20. The computer system of claim 15 wherein the program code that causes the processor to sample the batch comprises program code that causes the processor to:
set a size of the first sub-batch to a value n; and
sample n data instances from the training dataset in accordance with the importance sampling probabilities.

21. The computer system of claim 15 wherein the program code that causes the processor to sample the batch further comprises program code that causes the processor to:
sample B−n data instances from the prior batch in accordance with a set of sampling probabilities different from the importance sampling probabilities, wherein B is a desired batch size for the batch.
